(19) United States
(12) Patent Application Publication
(10) Pub. No.: US 2014/0229524 A1
(43) Pub. Date: Aug. 14, 2014

(54) NETWORK COMMUNICATION LATENCY

(71) Applicant: METEOR DEVELOPMENT GROUP, INC., San Francisco, CA (US)

(72) Inventors: Geoffrey Robert Schmidt, San Francisco, CA (US); Nicholas C. Martin, Berkeley, CA (US); Matthew DeBergalis, San Francisco, CA (US); David Glasser, San Francisco, CA (US)

(73) Assignee: METEOR DEVELOPMENT GROUP, INC., San Francisco, CA (US)

(21) Appl. No.: 13/763,585

(22) Filed: Feb. 8, 2013

(51) Int. Cl. H04L 29/06

(52) U.S. Cl. CPC H04L 67/42
USPC 709/203

(57) ABSTRACT

Embodiments disclosed herein may relate to at least partially addressing latency, such as network communication latency, as may occur between a client and server, for example.

### BACKGROUND

1. Field

Subject matter disclosed herein may relate to network communication latency and may relate, more particularly, to at least partially addressing latency for applications involving communications between a client and a server, for example.

2. Information

The success of World Wide Web (Web) type applications continues to change the way the Internet, in general, and the Web, in particular, is utilized. Rather than being merely a convenient way to publish, for example, web pages may be transformed into Web-type computing devices and/or platforms. Compared with desktop applications, systems, such as systems online via the Web, may bring benefits such as, for example, universal accessibility and/or an ability to readily share, cooperate and/or communicate with others. Thus, continuing to improve performance remains desirable.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be understood by reference to the following detailed description if read with the accompanying drawings in which:

FIG. 1 is a schematic diagram illustrating an example system in accordance with an embodiment.

FIG. 2 is a flowchart illustrating an example process in accordance with an embodiment.

FIG. 2A is a flowchart illustrating another example process in accordance with another embodiment.

FIG. 3 is schematic diagram illustrating another example system in accordance with another embodiment.

FIG. 4 is a timeline diagram illustrating an example process in accordance with an embodiment.

FIG. 5 is a block diagram illustrating an example system comprising a plurality of computing devices coupled via a network in accordance with one or more embodiments.

Reference is made in the following detailed description to the accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components for clarity. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a network device may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

In this context, the term network device refers to any device capable of communicating via and/or as part of a network. Network devices may be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to devices communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise a device, such as a network device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting a network via a hardware bridge as one example may be done, although other approaches also exist. A hardware bridge, however, may not typically include a capability of interoperability via higher levels of a network protocol. A network protocol refers to a set of signaling conventions for communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility.

Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. In contrast, a virtual private network (VPN) may enable a remote device to communicate via a local network. A router may allow communications in the form of transmissions (e.g., signal packets), for example, to occur from a remote device to a VPN server on a local network. A remote device may be authenticated and a VPN server, for example, may create a special route between a local network and the remote device through an intervening router.

A network may be very large, such as comprising thousands of nodes, millions of nodes, billions of nodes, or more, as examples. In a Web-type or internet-type environment, for example, development of applications to be executed by a client and/or server, also referred to as online applications, may typically involve a programmer addressing issues that may arise due at least in part to tracking signaling dependencies. For example, a programmer may write code to capture and/or track changes to various signals and/or states within an application, such as one that may be executing on one or more clients and/or executing on one or more servers. The clients and servers may likewise exchange communications, such as signaling transmissions. Typically, although not necessarily, a signaling transmission may comprise a signal packet, which may comprise a source address, a destination address and payload, for example. Signaling transmissions may result in changes that it may be desirable to capture and/or track. It may be desirable that a client and a server separately executing an application be synchronized regarding the state of an application, for example, such as via synchronization of respective databases (e.g., portions thereof), as explained in more detail, for example.

Unfortunately, managing interactions between client and server computing devices may pose issues related to latency. For example, a client device may send one or more signal transmissions to a server device that may result in a change at the server device. The client device, therefore, may experience latency as it waits to receive a server communication to become synchronized with the change made at the server device. Latency experienced by a user operating a client device executing one or more applications locally may, therefore, result in applications appearing sluggish or unresponsive to a user, for example, which may produce an unsatisfactory user experience.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The internet has evolved to a public, self-sustaining facility that may be accessible to tens of millions of people or more worldwide. Also, in an embodiment, a widely used part of the Internet may comprise the World Wide Web, often abbreviated “WNW” or simply referred to as just “the web”. As mentioned, the terms Internet, web and/or similar terms may, therefore, be used interchangeably. The web, therefore, in this context, may comprise an Internet service that organizes stored content, such as, for example, text, images, video, etc., through the use of hypermedia. For example, a HyperText Markup Language (“HTML”) may be utilized to specify content and/or format of hypermedia type content, such as in the form of a file or an “electronic document,” such as a web page, for example. An Extensible Markup Language (XML) may also be utilized to specify content and/or format of hypermedia type content, such as in the form of a file or an “electronic document,” such as a web page, in an embodiment. Of course, HTML and XML are merely example languages provided as illustrations. Claimed subject matter is not intended to be limited to examples provided as illustrations, of course.

As used herein, a “web site” may refer to a collection of related web pages, in an embodiment. Also as used herein, “web page” may relate to any electronic file or electronic document, such as may be accessible via a network, by specifying a URL for accessibility via the web, in an example embodiment. As alluded to above, in one or more embodiments, a web page may comprise content coded using one or more languages, such as, for example, HTML and/or XML, although claimed subject matter is not limited in scope in this respect. Also, in one or more embodiments, application developers may write code in the form of JavaScript, for example, to provide content to populate one or more templates, such as for an application. In this context, the term template and/or similar terms refers to software or code that transforms input content into output content. However, JavaScript is merely an example programming language. As was mentioned, claimed subject matter is not limited to examples or illustrations.

As also mentioned, the success of World Wide Web (web) type applications continue to change the way the Internet, in general, and the Web, in particular, is utilized. Web pages may be transformed into Web-type computing devices. Compared with desktop applications, systems, such as systems online via the web, for example, may bring benefits, such as universal accessibility and/or an ability to readily share, cooperate and/or communicate with others. However, network communication latency, as mentioned, such as between a client and server exchanging communications, for example, may present challenges.

At least partially as a result of client-server type communications, a programmer may write code to capture and/or track changes in signaling (e.g., signal transmissions) and/or states, such as may take place as a result of client-server type communications. In an example embodiment, for example, a web page, such as available via a server, may include content from one or more different backend services and/or from a variety of databases and/or portions thereof. A programmer may further, therefore, write code to enable client computing devices to communicate with server computing devices that may potentially result in exchanges and/or modifications of content, such as within one or more databases and/or portions thereof accessible via a client or server. As an example, a server may modify an object stored in a database as a result of signal transmissions received from a client. Accurately tracking changes of this type, for example, may be challenging, particular in a network environment that includes network communication latency. Typically, custom code may be written to be executed by one or more client devices and one or more server devices, for example, to track changes in respective database content and/or to communicate changes between respective devices.

Since client and server devices may communicate via local area networks or wide area networks, a client device, for example, may experience noticeable round trip latency if communicating with a server device. Network latencies for wide area networks, for example, may range from tens to hundreds of milliseconds, and may be noticeable to a human user. Having a noticeable delay between a user initiating an action and the user observing the results of the action displayed on a client device may result in an application appearing clunky and/or unresponsive. Network communication latency, thus, potentially may result in user frustration, dissatisfaction, and/or in an overall disappointing experience in using an application.

However, an embodiment in accordance with claimed subject matter may employ techniques for at least partially addressing network communication latency, such as that may be experienced by a user interacting with an application executing on a client device that communicates and may synchronize with a server device, for example. In an embodiment, strategies may be employed to provide nearly immediate, or approximately immediate, feedback to a user interacting with a remote service (e.g., one or more remote servers) over a network connection from a client, as explained in more detail below.

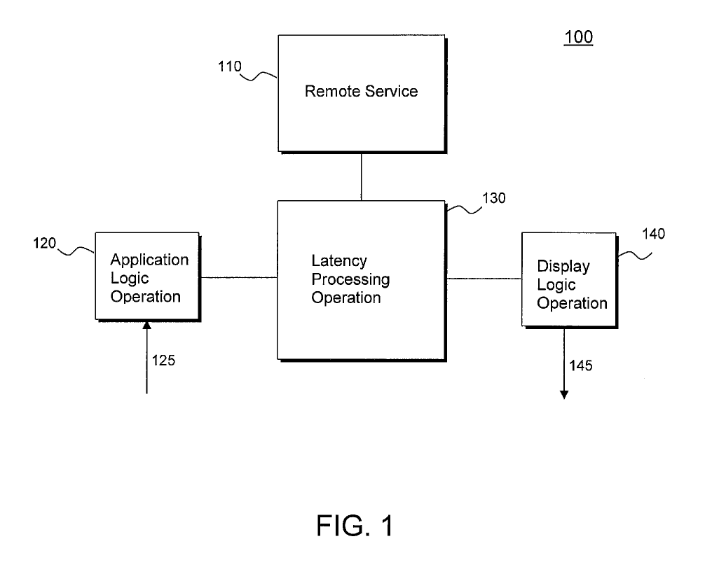

FIG. 1 is a schematic diagram illustrating an example system for at least partially addressing latency, such as network communication latency, in accordance with an embodiment 100. For example, for system embodiment 100, an application logic operation 120 is depicted. Application logic operation 120 may, for example, comprise executable code developed by an application developer. In this context, any of a wide range of application types may be implemented in this manner, such as, for example, applications related to banking, financial, games, social networking, and so forth. Claimed subject matter is not intended to be limited in scope to any particular type of application.

Also, in an embodiment, an application developer may write essentially one set of executable code that may be executed both on a client computing device and on a server computing device, such as remote service 110, without making substantial modifications to the code, although claimed subject matter is not limited in scope in this respect. In an embodiment, application logic operation 120 may comprise code executable by a client computing device to receive, such as via mouse clicks, keyboard key strokes, touch screen contact, etc., requests which may then result in transmissions being initiated to remote service 110 from a client computing device, for example, to communicate requests. In an embodiment, for example, one or more operations to be performed on one or more objects stored in a database of remote service 110, for example, may be represented by clicks, key strokes, screen contact, etc., entered via a client device.

Also, in an embodiment, an application developer may provide display logic operation 140. Display logic operation 140 may comprise code executable by a client computing device to display results 145, such as may be received from remote service 110, provided at least in part in response to one or more requests, such as those previously discussed, that may be initiated by a user, for example, via a client computing device.

To reduce a perception of a delay, such as may be experienced by a user, entering one or more requests and observing one or more displayed results, such as 145, a latency processing operation 130 may be executed. In an embodiment, latency processing operation 130 may simulate (e.g., mimic) one or more operations substantially in accordance with one or more entered requests and may provide one or more results of the one or more simulated operations (e.g., simulated or mimicked results) to display logic operation 140. Thus, simulated results may be displayed to provide nearly, or at least approximately, immediate feedback capable of being perceived by a user while one or more operations are being processing, such as via transmissions to remote service 110. In this context, the terms simulate, mimic, and/or similar terms refers to at least approximately imitating processing and/or behavior. These terms include, as an illustrative example, a situation in which a client and server have common aspects related to respective computing environments so that, for example, nearly the same code or at least substantially similar code may be executed in the respective computing environments. Thus, for example, a client may simulate or mimic processing that may occur at a server. However, it is also understood that it is not required that nearly the same or substantially similar code be employed. For example, a client may simulate or mimic processing that may occur at a server by executing different code that may, for example, be written in a different programming language. Likewise, it may be desirable in an embodiment, for example, to have differences between processing at a server and simulated or mimicked processing at a client. For example, for convenience, differences in security, differences in processing power, differences in power consumption, or any one of a host of other reasons, there may be different operations performed by a client simulating or mimicking server processing. Thus, imitation of processing and/or behavior does not necessarily require, and may not in many cases result in identical imitation. Rather, a reasonably approximate imitation typically may be sufficient.

In an embodiment, for example, a method may comprise determining if a display event request, such as may be made by a user, potentially affects one or more locally mimicked outstanding display event requests. A display event request refers to a user entered request made via a local client that has potential to result in an event producing a change observable to a user through a display at the client after being fully processed by a remote server and synchronized locally at the client. A locally mimicked outstanding display event request refers to a display request that has been mimicked locally at a client and in which remote server results, such as in the form of signal packet transmissions, reflecting remote server processing of the display event request, are yet to be received. If it is determined that a display event request does not potentially affect one or more locally mimicked outstanding display event requests, the display event request may be mimicked locally at a client computing device ahead of receiving one or more remote server generated signal transmissions corresponding to processing of the display event request by the remote server.

As explained in more detail later, mimicking a display event typically includes modifying a locally accessible database in accordance with the display event request. Likewise, a determination regarding whether to update a display substantially in accordance with one or more modifications to a locally accessible database may be made. A number of approaches to tracking one or more modifications to a locally accessible database are also possible, as explained. For example, one or more modifications to a locally accessible database may be tracked on a per object basis, on a per file basis, or on a per sub-object basis, to provide a few examples.

At some point, one or more remote server generated signal transmissions corresponding to processing of a display event request by a remote server may be received. It is noted that processing by a remote server may include updating a database accessible by the remote server. That database may also likewise be updated on a per object basis, on a per file basis, or on a per sub-object basis, to provide a few examples. After receiving signal transmissions generated by a remote server, a locally accessible database (e.g., accessible by the client) may be updated with received remote server generated signal transmissions if different from one or more modifications made to the locally accessible database ahead of receipt of the remote server generated signal transmissions. Likewise, a display may be updated substantially in accordance with the locally accessible database if remote server generated signal transmissions are different from one or more modifications made to the locally accessible database ahead of receipt of the remote server generated signal transmissions.

Another method embodiment may comprise determining if a display event request, such as may be made by a user, potentially affects one or more locally mimicked outstanding display event requests; however, if so, in this embodiment, for example, a determination may be made regarding whether to update a display after resolution of the display event request and after resolution of the potentially affected one or more locally mimicked outstanding display event requests. For example, simulated results may be generated and stored, such as previously described, in an embodiment. However, resolution of the potentially affected one or more locally mimicked outstanding display event requests, similar to previously described, may comprise receiving one or more remote server generated signal transmissions corresponding to processing of one or more locally mimicked outstanding display event requests by a remote server. A locally accessible database may, thus, be updated with received remote server generated signal transmissions if different than one or more modifications made ahead of receipt. Again, therefore, a determination may be made whether to update the display substantially in accordance with the locally accessible database if remote server generated signal transmissions are different from modifications made to the locally accessible database corresponding to the one or more locally mimicked outstanding display event requests. These aspects of these embodiments are discussed in more detail below to provide non-limiting illustrative examples.

As suggested above, embodiments in accordance with claimed subject matter may employ various example strategies for tracking results. For example, in an embodiment, a per-file strategy may be employed, whereby one or more simulated operations related to a specified electronic file may be tracked locally, for example. For another example embodiment, a per-object strategy may be implemented. For example, in an embodiment, a per-object strategy may be employed, whereby one or more simulated operations related to a specified object may be tracked locally, for example. Likewise, a per-sub-object strategy may be employed whereby one or more simulated operations related to a specified sub-object may be tracked locally, for example.

A variety of approaches may be employed to assessing whether, for example, operations that potentially affect files, objects, sub-objects, or attributes, may be related. It is not intended that claimed subject matter be limited in scope to a particular approach. However, in one embodiment, as an illustrative example, two operations may be considered to be related if the operations write to corresponding locations (e.g., entries) in a database, for example. If applying a particular approach, such as the previously example, it is noted that a consequence of an incorrect assessment may be considered relatively minor. For example, concluding one way incorrectly may result in delay in updating a display; however, concluding the other way incorrect may result in a momentarily change or flicker appearing on a display to a user. A particular approach may therefore balance risks associated with these respective consequences, for example.

Nonetheless, continuing with the illustrative example above, as an operation may be mimicked or simulated, identities of affected entries (e.g., that were “written to”) may be tracked, via functionality of a database, for example. Then, to determine if an update from a server, for example, is “related to” a locally mimicked operation, a determination may be made if database entries modified by the server update were modified by the locally mimicked operation. Of course, again, this is merely an illustration and claimed subject matter is not intended to be limited to illustrative examples.

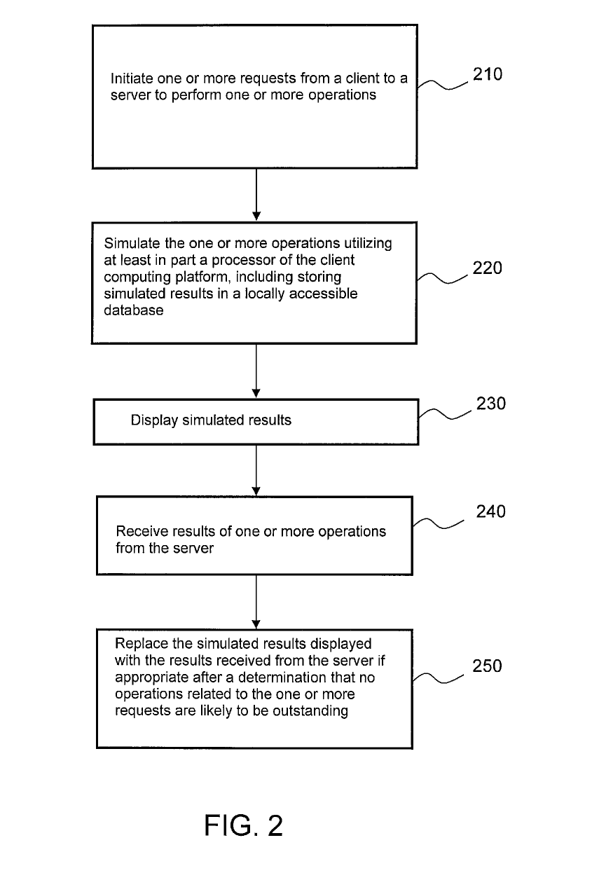

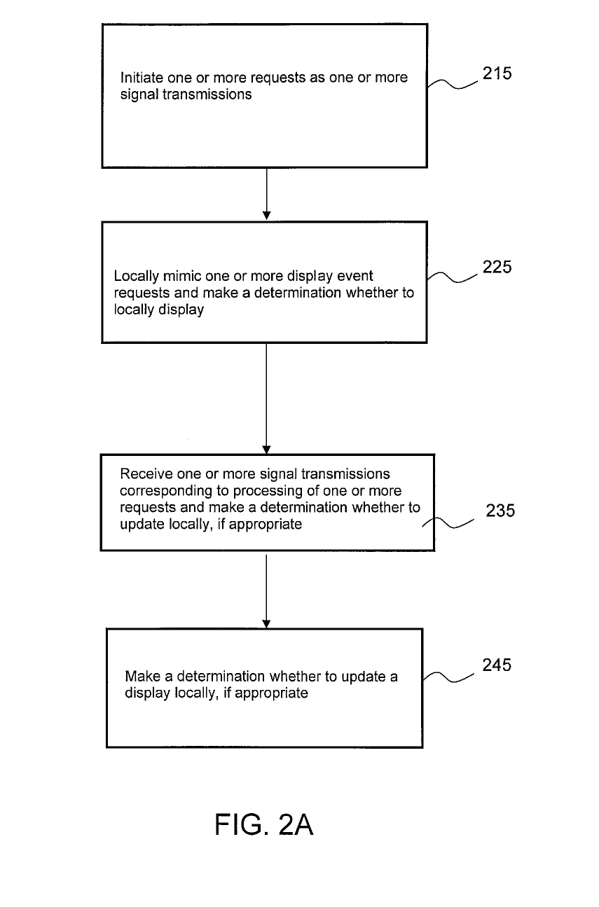

FIG. 2A is a flow diagram illustrating an example process in accordance with an embodiment. Of course, claimed subject matter may include all of blocks 215-245, less than blocks 215-245, or more than blocks 215-245. Further, the order of blocks 215-245 is merely an example order, and claimed subject matter is not limited in scope in this respect.

Block 215 illustrates initiating one or more requests, such as one or more display event requests, from a client to a server, for example. An initiated request, such as a display event request, may potentially result in one or more operations at a server in connection with processing an initiated request. For example, in an embodiment, a server receiving a request, such as in the form of one or more signal transmissions, may execute one or more operations. In an embodiment, executing one or more operations may include accessing one or more databases, or portions thereof, such as one or more entries, and making one or more modifications. Throughout this document, although for ease of description it may be convenient to refer to a request, an operation, a signal transmission, a modification and/or an entry, it shall be understood that there terms are intended to encompass one or more requests, one or more operations, one or more transmissions, one or more modifications and/or one or more entries.

However, as described previously, processing at a server and time for communications to travel from a client to a server and then from a server to a client, for example, may result in latency. In an embodiment, to at least partially address potential latency, as illustrated at block 225, a client may locally mimic performance of one or more display event requests ahead of receiving one or more remote server generated signal transmissions corresponding to server processing of the one or more display event requests, for example. In an embodiment, locally mimicking performance may include making one or more modifications to one or more entries of one or more locally accessible databases, or portions thereof, in which entries may comprise a local version of entries located at the server, for example. Likewise, in an embodiment, a determination made be made whether locally to update a display substantially in accordance with the one or more modifications.

As shown at block 235, a client may at some time later receive one or more signal transmissions corresponding to one or more requests made to the server. The received signal transmissions may provide results of processing the one or more requests by the server, such as, in an embodiment, by making one or more modifications to one or more entries of one or more databases, or portions thereof, accessible by the server. Making one or more modifications to one or more entries may constitute processing the one or more requests at the server. Likewise, the one or more received signal transmissions may communicate the one or more modifications by the server to the client. Therefore, a client may update one or more locally accessible databases, or portions thereof, with the one or more modifications provided by the server in the form of signal transmissions, again, as illustrated at block 235, if appropriate. For example, the one or more modifications indicated by the server may differ from the modifications made locally; however, if not, it may not be necessary to make a local update. Likewise, as illustrated, at block 245, a determination may be made whether to update a display locally, if appropriate, substantially in accordance with the one or more modifications. Again, if modifications differ, an update to a display may be executed.

FIG. 2 is a flow diagram illustrating another example process in accordance with another embodiment. Of course, claimed subject matter may include all of blocks 210-250, less than blocks 210-250, or more than blocks 210-250. Further, the order of blocks 210-250 is merely an example order, and claimed subject matter is not limited in scope in this respect. At block 210, one or more requests to perform one or more operations may be initiated, such as from a client to a server. In an embodiment, the one or more requests may relate to one or more databases, or specified subsets or portions thereof, for example, stored in a manner accessible by a server to which the one or more requests are initiated. In an embodiment, one or more signal transmissions may be initiated at least in part in response to receiving one or more user entries at a client, such as may be made via an input/output device, such as a mouse, keyboard, touch screen, etc.

As further depicted in the example flow diagram of FIG. 2, one or more operations, such as may be related to one or more specified subsets of one or more databases, for example, may be simulated locally, such as by utilizing, at least in part, a processor of a client. In an embodiment, simulating one or more requests may include executing code locally to simulate one or more operations that may be performed at the server. For example, as previously described, reasonably similar code may be executed, although claimed subject matter is not limited in scope in this respect. In an embodiment, for example, one or more modifications to one or more database entries may be stored as simulated results in a locally accessible database, such as a cache, accessible by the client, for example. Additionally, a determination may be made to display simulated results, as depicted at block 230. Later, results may be received from the server of the one or more operations corresponding to the one or more requests, as further depicted at block 240, for example. After a determination that it is likely that no operations remain to be executed by the server corresponding to the initiated requests, if appropriate, simulated results may be replaced with received results. For example, a locally accessible database may be updated.

In an embodiment, for example, one or more subsets of one or more databases may comprise one or more objects (e.g., for databases). An object may, for example, comprise one or more attributes associated with an object identifier. Also, in an embodiment, an object, or attributes thereof, may vary in size from one or more bits stored as memory states to several thousand bytes or more stored as memory states, for example. Thus, in an embodiment, a database may comprise objects that may vary in size. However, these are merely examples of attributes and/or objects, such as for a database. It is intended that claimed subject matter not be limited to examples, such as those provided for illustrative purposes.

In an embodiment, a technique for at least partially addressing latency may include generating a local version of a database, such as in response to a user initiating one or more requests for one or more operations and may further include displaying signal or state values from the local version until outstanding requests are settled, or until a state of quiescence is reached, as further explained. For example, one or more user-initiated requests to perform one or more operations may be made by a user at a client. At least in part in response, results from a forked version of a local database, or a portion thereof, generated locally via simulation may be displayed locally. Subsequent user-initiated requests made while the client continues operating, but before receiving server processed results to the initiated requests, may also be made and implemented via simulation using a forked version of a local database. That is, the client may continue to execute simulations using a forked version of a database.

In an embodiment, as long as the client executes requests using the forked database version, results received from a server that may be related to the requests may be stored, such as using remote truth cache 326, until the client receives completed results for initiated requests that have been transmitted to the server. At least in part in response to receiving completed results for initiated requests and after a determination there are likely no remaining outstanding operations to be executed by the server, the client may be said to be in a quiescent state and a determination may be made to display results received from the server by updating a display, if appropriate. However, if received results do not differ from simulated results, a display update may not be needed.

On the other hand, so to speak, if appropriate, such as if results received differ from simulated results, results received from the server (e.g., modifications) may be made to a non-forked version of the database, and the forked version may be discarded, for example. In an embodiment, techniques may be employed in which a subset or portion of a database may be forked, rather than a complete or full database, for example, for better efficiency, although claimed subject matter is not limited in scope in this respect.

Another embodiment may include tracking which entries, such as objects, for example, in a local database may be modified, such as in accordance executing one or more requests through simulation. In an embodiment, for example, a client may maintain a list of initiated requests having one or more outstanding operations to be executed. In an embodiment, a client may, therefore, display updates to entries as results are received from a server if there is not a conflict in terms of entries in a database between those updates and one or more outstanding operations to be executed.

For one or more requests initiated via one or more transmissions to a server, for example, a client may perform one or more simulated operations using a local version of a database, or a portion thereof, and may further maintain a list of entries modified as a result. For entries modified as a result of one or more simulated operations performed at the client, the client may also maintain a list of simulated operations that modified the entries. The client may further maintain, such as in locally accessible storage, a version of entries that may include results of one or more operations processed by the server, that is, without any simulated operations, for example. In an embodiment, a version maintained by a client that may include results of one or more operations processed by a server without changes that result from simulated operations may be referred to as a “server version.”

In an embodiment, at least in part in response to receiving results from the server, a client may enter results for a “server version” of database entries, for example, maintained via the client. If one or more entries are determined to have not been modified by any simulated operations performed at the client, a determination may be made whether to display results received from the server related to the particular entries and, in accordance with the determination, the results may be displayed, if appropriate. At least in part in response to a determination that one or more entries were modified by one or more simulated operations for one or more requests that may remain outstanding (e.g., results of operations by the server are yet to be received), results received from the server may be stored via the “server version,” but updated results may not necessarily be displayed.

Additionally, in an embodiment, at least in part in response to a client receiving results to one or more outstanding requests from a server, the client may determine which entries may have been modified by local simulation of the requests. At least in part in response to results received from the server being determined to be final outstanding requests related to one or more particular entries, a “server version” of the particular entries may be updated, if appropriate, and a determination may be made to update a display, if appropriate.

In some example embodiments described herein, “per-object” techniques for tracking of database entries, for example, may be employed. However, claimed subject matter is not limited in scope in this respect. For example, embodiments may utilize “per-file” tracking. Likewise, “per-sub-object” tracking techniques may be employed in an embodiment, which may, for example, track attributes of an object.

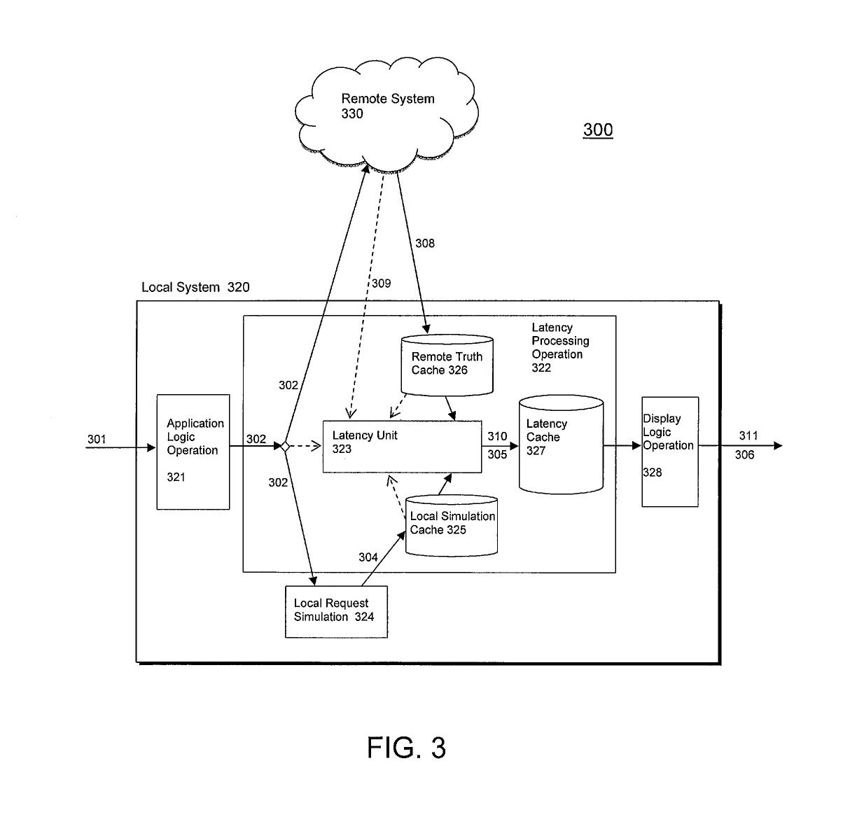

FIG. 3 is schematic diagram illustrating an example system in accordance with an embodiment 300. Example system embodiment 300 may comprise a local system 320 and a remote system 330. In an embodiment, local system 320 may comprise a client computing device or system. Remote system 330 may comprise a server computing device or platform, in an embodiment.

In an embodiment, a user may initiate a user action 301 (e.g., one or more user actions) via application logic operation 321. At least in part in response to receiving user action 301, application logic operation 321 may initiate transmission of a request 302 (e.g., one or more requests) to a remote system 330 and to a local request simulation unit 324. In an embodiment, local request simulation unit 324 may simulate the requested action, and may deliver simulated results 304 to a local simulation cache 325. A latency unit 323 may provide simulated results 304 to a latency cache 327, from which display logic operation 328 may access simulated results 304. Display logic operation 328 may include simulated results for display to a user, such as via display 306. In an embodiment, the user may observe simulated results without needing to wait for request 302 to travel to remote system 330 and without needing to wait for remote system 330 to provide processed results. In this manner, the application may appear to be more responsive to the user, potentially improving the user's experience in utilizing the application, for example.

As previously mentioned, remote system 330 may receive request 302 from application logic operation 321 approximately concurrently with local request simulation unit 324 performing simulated operations. At least in part in response to receiving request 302, remote system 330 may provide results 308 to a remote truth cache 326, such as may be stored at local system 320, in an embodiment. Remote system 330 may further provide content associated with results 308. In an embodiment, latency unit 323 may receive content 309, and may wait to display received results 308, which may include content 309.

At least in part in response to a determination whether to display results 308 received from remote system 330, latency unit 323 may provide received results to latency cache 327. In an embodiment, latency cache 327 may store simulated results 304 and received results 308, and display logic operation 328 may replace simulated results with received results, if appropriate. Likewise, a determination may be made whether to update display 311, if appropriate, in accordance with received results, for example.

In response to display logic operation updating display 311, if appropriate, the user may observe the updated display. In a situation where simulated results correspond with received results, an update may not be made and no change would be observed by the user, for example. In a situation where simulated results differ from received results, a display may be updated and the user may notice a change in the display.

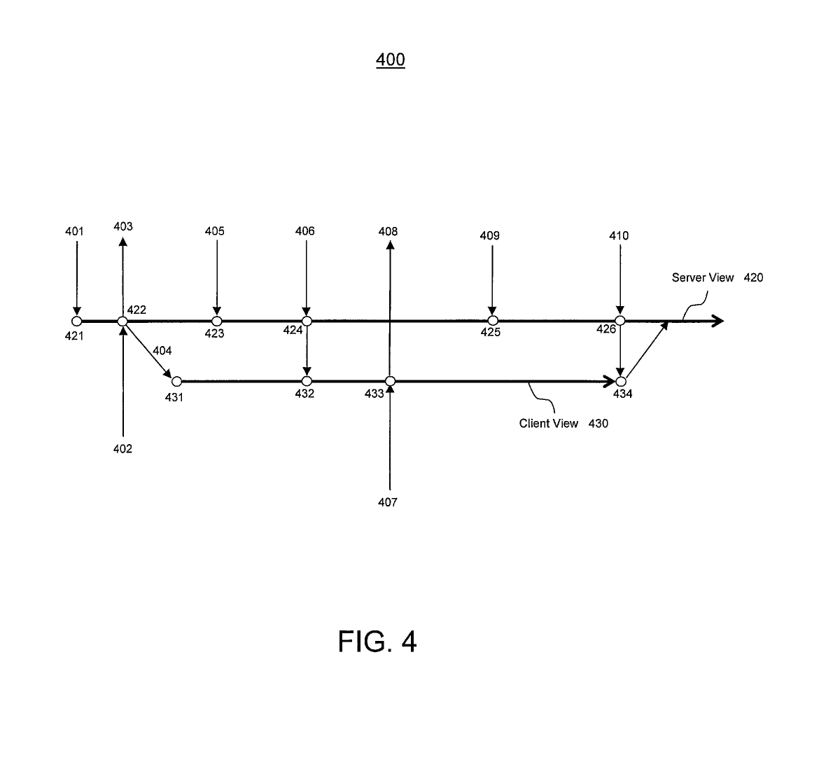

FIG. 4 is a timeline diagram illustrating an example process 400. In an embodiment, a technique may include generating a local version of a database, or portion thereof, in response to a user initiating a request (e.g., one or more requests) for an operation (e.g., one or more operations), such as on the database, and may further include displaying signal or state values from the local version until outstanding requests are settled, or until a state of quiescence is reached.

For example, an electronic entry 401 (e.g., one or more entries) may be stored in a database at a server at a time 421, for example. A user-initiated request 402 (e.g., one or more requests) to perform an operation (e.g., one or more operations) with respect to entries, such as 401, may be made. At least in part in response to the user-initiated request 402, a request 403 to modify one or more entries may be initiated to the server at time 422. Additionally, user-initiated request 402 may result in simulation 404 of the user-initiated operation performed at the client at time 431, which may include storing simulated results, such as in local simulation cache 325. Note that user-initiated request 402 results in separate operations performed at the server and at the client. For an example timeline 400 of FIG. 4, a top-most horizontal arrow may represent a server view 420, and a bottom-most horizontal arrow may represent a client view 430. A user may observe a display that represents client view 430, for example. In an embodiment, simulated results may be displayed at time 431, for example.

At time 423, content 405 in the form of signal transmissions may be received from the server. For the present example, content 405 may be related to request 403, although content 405 may not comprise content or results corresponding to request 403. In an embodiment, if content 405 is related to outstanding request 403, content 405 may be stored, such as in a local cache, for example, and may not necessarily be displayed at time 423. Further, in an embodiment, content 406 may be received from the server. For the present example, content 406 may not be related to request 403, and may, therefore, be displayed at time 432, after a determination is made whether to update the display and if it is appropriate to do so.

Additionally, for the example depicted in FIG. 4, an additional user-initiated request 407 may be made at the client at time 433. As was the case with user-initiated request 402, user-initiated request 407 may result in a local simulation generating simulated results for additional user-initiated request 207. Simulation results for additional request 407 may be displayed after a determination whether to update the display and if display is appropriate. Further, in addition to executing simulation at the client, and at least in part in response to additional user-initiated request 407, a corresponding additional request 408 may be initiated to the server.

At time 425 of the example timeline 400 of FIG. 4, a response 409 to the first request 403 may be received. In an embodiment, simulated results may be displayed until requests associated with particular entries have been fulfilled, after which, received results for the various requests related to the specified entries may be displayed, if appropriate, such as by updating database entries and updating a display, for example. Referring again to FIG. 4, a response 409 to the first request 403 may be received at time 425, but if a second request 408 remains outstanding, response 409 may be stored and not necessarily displayed. At time 426, a result 410 to the second request 408 may be received. At time 426, outstanding requests associated with the specified database entries have been fulfilled, and it is likely no requests and/or operations remain outstanding. Therefore, at time 434, simulated results previously displayed as part of client view 430 may be replaced with received results received from the server, if appropriate due to differing results. Likewise, client view 430 and server view 420 with respect to the specified entries become synchronized. In other words, content stored at the server related to the specified entries matches content stored at the client, and the user is able to view the results provided by the server.

As used herein, the term “entry”, “electronic entry”, “document”, “electronic document” and/or similar terms are meant to refer to signals and/or states in a digital format that may be perceived by a user if displayed by a digital device, such as, for example, a computing device. For one or more embodiments, an electronic document may comprise a web page coded in a markup language, such as, for example, HTML (hypertext markup language). In another embodiment, an electronic document may comprise a portion or a region of a web page. However, claimed subject matter is not limited in these respects. Also, for one or more embodiments, an electronic document or electronic entry may comprise a number of components. Components in one or more embodiments may comprise text, for example as may be displayed on a web page. Also for one or more embodiments, the components may comprise a graphical object, such as, for example, a digital image, or sub-objects, such as attributes thereof.

Example timeline 400 depicted in FIG. 4 illustrates an example embodiment utilizing per-entry tracking. Other embodiments may perform tracking on a variety of bases, such as per-file, per-object, or per-sub-object, to provide a few examples. Rather than waiting until outstanding requests related to specified entries have been completed to update a display, an embodiment employing per-object tracking, for example, may allow results not related to specified objects to be displayed via update, even if one or more requests related to specified objects remain outstanding. Received results related to specified objects may be displayed at least in part in response to a determination that no operations likely remain outstanding related to the specified objects. For a situation where one or more operations related to the specified objects remain outstanding, results received from the server related to the specified objects may be stored, such as in remote truth cache 326, for example.

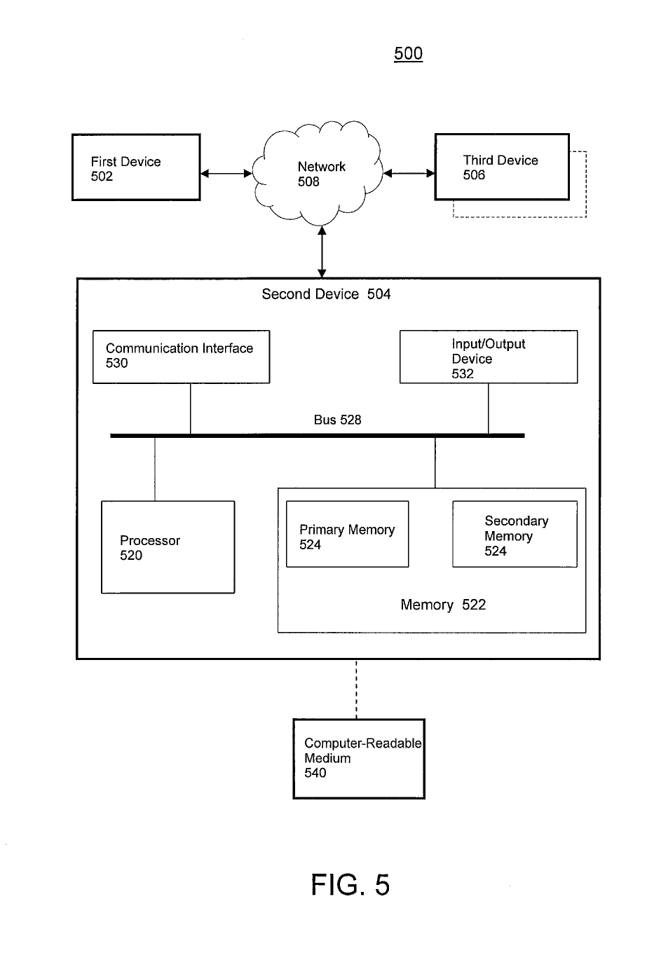

FIG. 5 is a schematic diagram illustrating an example embodiment 500 of a computing environment system that may include one or more devices to implement techniques and/or processes described above in connection with at least partially addressing latency, discussed above in connection with FIGS. 1-4, for example. System 500 may include, for example, a first device 502, a second device 504, and a third device 506, which may be operatively coupled together through a network 508.

First device 502, second device 504 and third device 506, as shown in FIG. 5, may be representative of any device, appliance or machine that may exchange signals via network 508. By way of example but not limitation, any of first device 502, second device 504, or third device 506 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources to support exchange of content between at least two of first device 502, second device 504, and third device 506. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 506, there may be additional like devices operatively coupled to network 508. It is recognized that all or part of the various devices and/or networks shown in system 500, and/or processes and/or methods as further described herein, for example, or otherwise, may be implemented using or otherwise include hardware, firmware, software, or any combination thereof (other than software per se).

Thus, by way of example, but not limitation, second device 504 may include at least one processor 520 operatively coupled to a memory 522 through a bus 528. Processing unit or processor 520 may be representative of one or more circuits to perform at least a portion of a computing procedure or process. By way of example, but not limitation, processing unit 520 may include one or more controllers, microprocessors, microcontrollers, application specific integrated circuits, digital signal processors, programmable logic devices, field programmable gate arrays, and the like, or any combination thereof.

Memory 522 may be representative of any storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more storage devices or systems, such as, for example, a disk drive, an optical disc drive, a tape drive, a solid state memory drive, etc. In certain implementations, secondary memory 526 may be operatively receptive of, or otherwise capable of being coupled to, a computer-readable medium 540. Computer-readable medium 540 may include, for example, any medium that can carry and/or make accessible content, code and/or instructions for one or more of the devices in system 500.

Second device 504 may include, for example, a communication interface 530 that provides for or otherwise supports operative coupling of second device 504 to at least network 508. By way of example, but not limitation, communication interface 530 may include a network interface device or card, a modem, a router, a switch, a transceiver, and the like.

Second device 504 may include, for example, an input/output device 532. Input/output device 532 is representative of one or more devices or features to accept or otherwise introduce human and/or machine input entries, and/or one or more devices or features that may deliver or otherwise provide for human and/or machine output signals. By way of example but not limitation, input/output device 532 may include a display, speaker, keyboard, mouse, trackball, touch screen, data port, etc.

The term “computing platform” as used herein refers to a system and/or a device that includes an ability to process and/or store data in the form of signals or states. Thus, a computing platform, in this context, may comprise hardware, software, firmware or any combination thereof (other than software per se). Computing platform 500, as depicted in FIG. 5, is merely one such example, and claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, mobile audio or video playback or recording devices, or any combination of the above. Further, unless specifically stated otherwise, a process as described herein, with reference to flow diagrams or otherwise, may also be executed and/or controlled, in whole or in part, by a computing device.

Methodologies described herein may be implemented by various techniques depending, at least in part, on applications according to particular features or examples. For example, methodologies may be implemented in hardware, firmware, or combinations thereof, along with software (other than software per se). In a hardware embodiment, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform functions, such as described herein, combinations thereof, or otherwise.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change and/or transformation in magnetic orientation or a physical change and/or transformation in molecular structure, such as from crystalline to amorphous or vice-versa. In still other memory devices, a change in physical state may involve quantum mechanical phenomena, such as, superposition, entanglement, or the like, which may involve quantum bits (qubits), for example. The foregoing is not intended to be an exhaustive list of all examples in which a change in state from a binary one to a binary zero or vice-versa in a memory device may comprise a transformation, such as a physical transformation. Rather, the foregoing are intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has been illustrated and/or described what are presently considered to be example features, it will be understood by those skilled in the art that various other modifications may be made, and/or equivalents may be substituted, without departing from claimed subject matter. Additionally, many modifications may be made in which as a result a particular situation falls within claimed subject matter without departing from one or more central concepts described herein, for example. Therefore, it is intended that claimed subject matter not be limited to the particular examples disclosed, but that such claimed subject matter may also include all aspects falling within appended claims, and/or equivalents thereof.

1. A method, comprising:
transmitting from a client computing platform to a server computing platform a request to perform an operation related to a specified subset of a database stored at the server computing platform at least in part in response to receiving a user input at the client computing platform;
simulating the operation related to the specified subset of the database utilizing at least in part a processor of the client computing platform, including storing a simulated result in a local database cache stored at the client computing platform;
displaying the simulated result to the user;
receiving a result of the operation related to the specified subset of the database from the server computing platform; and
replacing the simulated result displayed to the user with the result received from the server computing platform at least in part in response to a determination that no operations related to the specified subset of the database are outstanding.

2. The method of claim 1, further comprising:
storing the result of the operation received from the server computing platform in the local database cache; and
not displaying the result of the operation received from the server computing platform at least in part in response to a determination that one or more operations related to the specified subset of the database are outstanding.

3. The method of claim 2, further comprising:
receiving an additional result from the server computing platform;
determining whether the additional result is related to the specified subset of the database; and
displaying the additional result to the user at least in part in response to a determination that the additional result is not related to the specified subset of the database regardless of whether any operations related to the specified subset of the database are outstanding.

4. The method of claim 1, wherein the specified subset of the database comprises a specified object in the database.

5. The method of claim 4, wherein said replacing the simulated result with the result received from the server computing platform comprises:
tracking operations related to the specified object;
detecting whether any operations related to the specified object are currently outstanding; and
replacing the simulated result with the result received from the server computing platform at least in part in response to a determination that no operations related to the specified object are outstanding.

6. The method of claim 5, further comprising:
receiving a second result from the server computing platform; and
displaying the second result to the user at least in part in response to a determination that the second result is unrelated to the specified object.

7. The method of claim 6, wherein said displaying the second result to the user at least in part in response to a determination that the second result is unrelated to the specified object comprises displaying the second result regardless of whether any operations related to the specified object are outstanding.

8. The method of claim 7, wherein said second result is related to a second object, and wherein said displaying the second result further comprises displaying the second result at least in part in response to a determination that no operations related to the second object are outstanding.

9. The method of claim 1, wherein the subset of the database comprises an electronic document.

10. The method of claim 9, wherein said replacing the simulated result with the result received from the server computing platform comprises:
tracking all operations related to the electronic document;
detecting whether all operations related to the electronic document have been completed; and
replacing the simulated result with the result received from the server computing platform at least in part in response to a determination that all operations related to the electronic document have been completed.

11. The method of claim 9, wherein the electronic document comprises a region of a web page.

12. An apparatus, comprising: a processor to:
initiate transmission of a request to perform an operation related to a specified subset of a database stored at a server computing platform to the server computing platform at least in part in response to receiving a user input;
simulate the operation related to the specified subset of the database, including storing a simulated result in a local database cache;
display the simulated result to the user;
obtain a result of the operation related to the specified subset of the database from the server computing platform; and
replace the simulated result displayed to the user with the result received from the server computing platform at least in part in response to a determination that no operations related to the specified subset of the database are outstanding.

13. The apparatus of claim 12, the processor further to:
store the result of the operation received from the server computing platform in the local database cache; and
not display the result of the operation received from the server computing platform at least in part in response to a determination that one or more operations related to the specified subset of the database are outstanding.

14. The apparatus of claim 13, the processor further to:
obtain an additional result from the server computing platform;
determine whether the additional result is related to the specified subset of the database; and
display the additional result to the user at least in part in response to a determination that the additional result is not related to the specified subset of the database regardless of whether any operations related to the specified subset of the database are outstanding.

15. The apparatus of claim 12, wherein the specified subset of the database comprises a specified object in the database.

16. The apparatus of claim 15, the processor to replace the simulated result with the result received from the server computing platform at least in part by:
tracking operations related to the specified object;
detecting whether any operations related to the specified object are currently outstanding; and
replacing the simulated result with the result received from the server computing platform at least in part in response to a determination that no operations related to the specified object are outstanding.

17. The apparatus of claim 16, the processor further to:
obtain a second result from the server computing platform; and
display the second result to the user at least in part in response to a determination that the second result is unrelated to the specified object.

18. The apparatus of claim 17, the processor to display the second result to the user at least in part by displaying the second result regardless of whether any operations related to the specified object are outstanding.

19. The apparatus of claim 18, wherein said second result is related to a second object, the processor to display the second result at least in part by displaying the second result at least in part in response to a determination that no operations related to the second object are outstanding.

20. The apparatus of claim 12, wherein the subset of the database comprises an electronic document.

21. The apparatus of claim 20, the processor to replace the simulated result with the result received from the server computing platform at least in part by:
tracking all operations related to the electronic document;
detecting whether all operations related to the electronic document have been completed; and
replacing the simulated result with the result received from the server computing platform at least in part in response to a determination that all operations related to the electronic document have been completed.

22. The apparatus of claim 20, wherein the electronic document comprises a region of a web page.

23. An article, comprising: a storage medium having stored thereon instructions executable by a processor of a client computing platform to:
initiate transmission of a request to perform an operation related to a specified subset of a database stored at a server computing platform to the server computing platform at least in part in response to receiving a user input at the client computing platform;
simulate the operation related to the specified subset of the database, including storing a simulated result in a local database cache of the client computing platform;
display the simulated result to the user;
obtain a result of the operation related to the specified subset of the database from the server computing platform; and
replace the simulated result displayed to the user with the result received from the server computing platform at least in part in response to a determination that no operations related to the specified subset of the database are outstanding.

24. The article of claim 23, wherein the storage medium has stored thereon further instructions executable by the processor of the client computing platform to:
store the result of the operation received from the server computing platform in the local database cache; and
not display the result of the operation received from the server computing platform at least in part in response to a determination that one or more operations related to the specified subset of the database are outstanding.

25. The article of claim 24, the processor further to:
obtain an additional result from the server computing platform;
determine whether the additional result is related to the specified subset of the database; and
display the additional result to the user at least in part in response to a determination that the additional result is not related to the specified subset of the database regardless of whether any operations related to the specified subset of the database are outstanding.

26. The article of claim 24, wherein the specified subset of the database comprises a specified object in the database.

27. The article of claim 26, wherein the storage medium has stored thereon further instructions executable by the processor of the client computing platform to replace the simulated result with the result received from the server computing platform at least in part by:
tracking operations related to the specified object;
detecting whether any operations related to the specified object are currently outstanding; and
replacing the simulated result with the result received from the server computing platform at least in part in response to a determination that no operations related to the specified object are outstanding.

28. The article of claim 27, wherein the storage medium has stored thereon further instructions executable by the processor of the client computing platform to:
obtain a second result from the server computing platform; and
display the second result to the user at least in part in response to a determination that the second result is unrelated to the specified object.

29. The article of claim 28, wherein the storage medium has stored thereon further instructions executable by the processor of the client computing platform to display the second result to the user at least in part by displaying the second result regardless of whether any operations related to the specified object are outstanding.

30. The article of claim 29, wherein said second result is related to a second object, and wherein the storage medium has stored thereon further instructions executable by the processor of the client computing platform to display the second result at least in part by displaying the second result in response to a determination that no operations related to the second object are outstanding.

31. The article of claim 24, wherein the subset of the database comprises an electronic document.

32. The article of claim 31, wherein the storage medium has stored thereon further instructions executable by the processor of the client computing platform to replace the simulated result with the result received from the server computing platform at least in part by:
tracking all operations related to the electronic document;
detecting whether all operations related to the electronic document have been completed; and
replacing the simulated result with the result received from the server computing platform at least in part in response to a determination that all operations related to the electronic document have been completed.

33. The article of claim 31, wherein the electronic document comprises a region of a web page.

34. A method comprising: determining if a display event request potentially affects one or more locally mimicked outstanding display event requests; and
mimicking the display event request ahead of receiving one or more remote server generated signal transmissions corresponding to the display event request if not.

35. The method of claim 34, wherein the mimicking the display event comprises:
modifying a locally accessible database in accordance with the display event request.

36. The method of claim 35, and further comprising:
making a determination regarding whether to update a display substantially in accordance with the modification to the locally accessible database.

37. The method of claim 35, wherein modifications to the locally accessible database comprise modifications on a per object basis.

38. The method of claim 35, wherein modifications to the locally accessible database comprise modifications on a per file basis.

39. The method of claim 35, wherein modifications to the locally accessible database comprise modifications on a per sub-object basis.

40. The method of claim 35, and further comprising: receiving one or more remote server generated signal transmissions corresponding to processing of the display event request by a remote server.

41. The method of claim 40, wherein processing of the display event request by a remote server comprises making modifications to an accessible database on a per object basis.

42. The method of claim 40, wherein processing of the display event request by a remote server comprises making modifications to an accessible database on a per file basis.

43. The method of claim 40, wherein processing of the display event request by a remote server comprises making modifications to an accessible database on a per-sub-object basis.

44. The method of claim 40, and further comprising: updating the locally accessible database with the received remote server generated signal transmissions and updating the display substantially in accordance with the locally accessible database if the remote server generated signal transmissions are different from the modification to the locally accessible database.

45. A method comprising: determining if a display event request potentially affects one or more locally mimicked outstanding display event requests; and
making a determination regarding whether to update a display after resolution of the display event request and of the potentially affected one or more locally mimicked outstanding display event requests if so.

46. The method of claim 45, wherein resolution of the potentially affected one or more locally mimicked outstanding display event requests comprises:
receiving one or more remote server generated signal transmissions corresponding to processing of the one or more locally mimicked outstanding display event requests by a remote server.

47. The method of claim 46, and further comprising: updating a locally accessible database with the received remote server generated signal transmissions.

48. The method of claim 47, and further comprising: making a determination whether to update the display substantially in accordance with the locally accessible database if the remote server generated signal transmissions are different from modifications to the locally accessible database corresponding to the one or more locally mimicked outstanding display event requests.

49. The method of claim 47, wherein modifications to the locally accessible database comprise modifications on a per object basis.

50. The method of claim 47, wherein modifications to the locally accessible database comprise modifications on a per file basis.

51. The method of claim 47, wherein modifications to the locally accessible database comprise modifications on a per sub-object basis.

52. An article comprising: a storage medium having stored thereon instructions executable by a processor to: determine if a display event request potentially affects one or more locally mimicked outstanding display event requests; and
mimic the display event request ahead of receiving one or more remote server generated signal transmissions corresponding to the display event request if not.

53. The article of claim 52, wherein the instructions executable to further mimic the display event including to modify a locally accessible database in accordance with the display event request.

54. The article of claim 53, wherein the instructions executable to further make a determination regarding whether to update a display substantially in accordance with the modification to the locally accessible database.

55. The article of claim 53, wherein the instructions executable to further modify the locally accessible database on a per object basis.

56. The article of claim 53, wherein the instructions executable to further modify the locally accessible database on a per file basis.

57. The article of claim 53, wherein the instructions executable to further modify the locally accessible database on a per sub-object basis

58. An article comprising: a storage medium having stored thereon instructions executable by a processor to: determine if a display event request potentially affects one or more locally mimicked outstanding display event requests; and
make a determination regarding whether to update a display after resolution of the display event request and of the potentially affected one or more locally mimicked outstanding display event requests if so.

59. The article of claim 58, wherein said instructions are further executable to resolve the potentially affected one or more locally mimicked outstanding display event requests including to receive one or more remote server generated signal transmissions corresponding to processing of the one or more locally mimicked outstanding display event requests by a remote server.

60. The article of claim 59, wherein said instructions are further executable to update a locally accessible database with the received remote server generated signal transmissions.

61. The article of claim 60, wherein said instructions are further executable to modify the locally accessible database on a per object basis.

62. The article of claim 60, wherein said instructions are further executable to modify the locally accessible database on a per file basis.

63. The article of claim 60, wherein said instructions are further executable to modify the locally accessible database on a per sub-object basis.

64. An apparatus comprising: a computing platform to determine if a display event request potentially affects one or more locally mimicked outstanding display event requests; and to mimic the display event request ahead of receiving one or more remote server generated signal transmissions corresponding to the display event request if not.

65. The apparatus of claim 64, wherein the computing platform comprises a client.

66. The apparatus of claim 65, wherein the computing platform to further mimic the display event including to modify a locally accessible database in accordance with the display event request.

67. The apparatus of claim 66, wherein the computing platform to further make a determination regarding whether to update a display substantially in accordance with the modification to the locally accessible database.

68. The apparatus of claim 66, wherein the computing platform to further modify the locally accessible database on a per object basis.

69. The apparatus of claim 66, wherein the computing platform to further modify the locally accessible database on a per file basis.

70. The apparatus of claim 66, wherein the computing platform to further modify the locally accessible database on a per sub-object basis

71. The apparatus of claim 66, wherein the computing platform to further receive one or more remote server generated signal transmissions corresponding to processing of the display event request by a remote server.

72. The apparatus of claim 71, wherein the computing platform to further update the locally accessible database with the received remote server generated signal transmissions and update the display substantially in accordance with the locally accessible database if the remote server generated signal transmissions are different from the modification to the locally accessible database.

73. An apparatus comprising: a computing platform to determine if a display event request potentially affects one or more locally mimicked outstanding display event requests; and to make a determination regarding whether to update a display after resolution of the display event request and of the potentially affected one or more locally mimicked outstanding display event requests if so.

74. The apparatus of claim 73, wherein the computing platform to further resolve the potentially affected one or more locally mimicked outstanding display event requests including to receive one or more remote server generated signal transmissions corresponding to processing of the one or more locally mimicked outstanding display event requests by a remote server.

75. The apparatus of claim 74, wherein the computing platform to further update a locally accessible database with the received remote server generated signal transmissions.

76. The apparatus of claim 75, wherein the computing platform to further modify the locally accessible database on a per object basis.

77. The apparatus of claim 75, wherein the computing platform to further modify the locally accessible database on a per file basis.

78. The apparatus of claim 75, wherein the computing platform to further modify the locally accessible database on a per sub-object basis.
